(19) United States
(12) Patent Application Publication
(10) Pub. No.: US 2017/0010621 A1
(43) Pub. Date: Jan. 12, 2017

(54) PAVING COLLISION AVOIDANCE SYSTEM

(71) Applicant: Caterpillar Paving Products Inc., Brooklyn Park, MN (US)

(72) Inventors: Federico Rio, Brooklyn Park, MN (US); John Marsolek, Watertown, MN (US); Mark William Whiting, Peru, IL (US)

(73) Assignee: Caterpillar Paving Products Inc., Brooklyn Park, MN (US)

(21) Appl. No.: 15/270,371

(22) Filed: Sep. 20, 2016

(51) Int. Cl. G05D 1/02; E01C 23/01; E01C 19/22

(52) U.S. Cl. CPC G05D 1/0289; E01C 19/22; E01C 23/01; E01C 2301/00

(57) ABSTRACT

A paving collision avoidance system includes a paving machine, a compactor, and a controller. The compactor has a hydrostatic braking capability. The controller is configured to stop the compactor when it enters a predetermined boundary determined by the momentum of the compactor and the relative positions of the paving machine and the compactor.

### TECHNICAL FIELD

The present disclosure relates to a paving system including a paving machine and a compactor, and more particularly to a collision avoidance system for a compactor operating in proximity to a paving machine.

### BACKGROUND

A paving system includes a paving machine and a compactor. Traditionally, a paving machine lays asphalt to create a road surface. The paving machine is followed by one or more compactors to ensure the road surface reaches the desired compactability. The paving machine and the compactor operate in close proximity to each other on a worksite.

In order to achieve proper compaction of the asphalt laid by the paving machine, the compactor needs to travel at a high speed. In some examples, the compactor may have to travel at speeds above 7 kilometers per hour to achieve the desired compaction. Thus, the compactor approaches a rear end of the paving machine at high speeds. In some situations, the compactors may collide with the paving machine. For example, while travelling at high speeds, the compactors may hit a screed of the paving machine, which may increase downtime of the paving machine and the compactor.

U.S. Pat. No. 8,798,904 describes a device for determining the position of a road roller relative to a road finisher has a transceiver on the road roller for transmitting transmit signals and for receiving receive signals from at least two reference points on the road finisher spaced apart from each other. An evaluation unit determines the position of the road roller relative to the road finisher from the run time between transmitting the transmit signals and receiving the receive signals from the reference points.

### SUMMARY OF THE DISCLOSURE

In one aspect of the present disclosure, a paving system is provided. The paving system includes a paving machine having a screed. The paving machine includes a first position detection module. The first position detection module is configured to generate a signal indicative of a current position of the paving machine. The paving machine also includes a first speed detection module. The first speed detection module is configured to generate a signal indicative of a speed of the compactor. The paving system also includes a compactor. The compactor includes a predefined weight stored thereon. The compactor also includes a second position detection module. The second position detection module is configured to generate a signal indicative of a current position of the compactor. The compactor further includes a second speed detection module. The second speed detection module is configured to generate a signal indicative of a speed of the compactor. The paving system further includes a controller in communication with the paving machine and the compactor. The controller is configured to receive signals indicative of the current position of each of the paving machine and the compactor respectively. The controller is also configured to receive signals indicative of the speed of each of the paving machine and the compactor respectively, and the predefined weight of the compactor. The controller is further configured to determine a predetermined boundary surrounding the paving machine based on the predefined weight, the speed, and the current position of the compactor. The controller is further configured to stop the compactor based on entering into the predetermined boundary, wherein the stopping is based on hydrostatic braking capability of the compactor.

Other features and aspects of this disclosure will he apparent from the following description and the accompanying drawings.

### BRIEF DESCRIPTION OF THE DRAWINGS

FIG. 1 is a diagrammatic view of an exemplary worksite having a paving machine and a compactor, according to various concepts of the present disclosure; and

FIG. 2 is a block diagram of a paving system associated with the worksite of FIG. 1, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

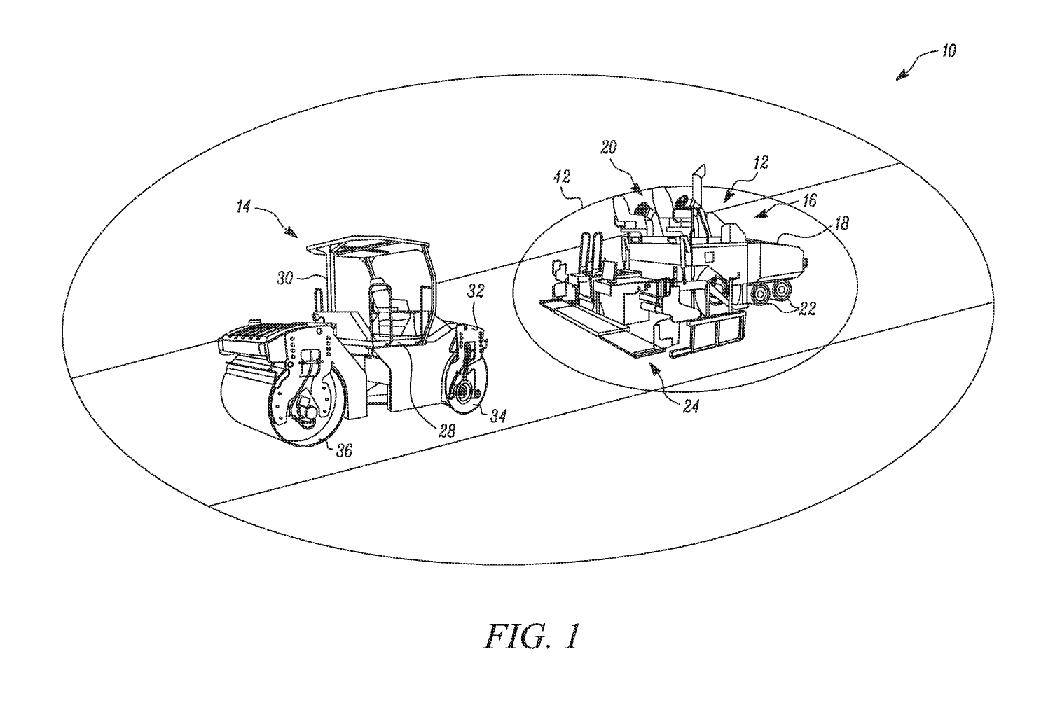

Referring to FIG. 1, the worksite 10 may be embodied as a construction worksite. In one example, the worksite 10 may include any one of a roadway, highway, parking lot, etc. A number of machines 12, 14 may operate at the worksite 10. A type of the machine 12, 14 may vary based on a type of operation that needs to be performed at the worksite 10. Accordingly, the machines 12, 14 may include, but is not limited to, a milling machine, a dump truck, etc.

In the illustrated embodiment, the machine 12 is embodied as a paving machine and the machine 14 is embodied as a compactor. The machine 12 will be hereinafter interchangeably referred to as paving machine 12, whereas, the machine 14 will be hereinafter interchangeably referred to as compactor 14. Although a single paving machine 12 and a single compactor 14 is shown in the accompanying figures, the number of machines operating at the worksite 10 may vary based on system requirements.

The paving machine 12 and the compactor 14 may be autonomous, semi-autonomous, or manually operated. In an example in which the paving machine 12 and the compactor 14 are autonomous or semi-autonomous, an operator seated at a remote location may operate the paving machine 12 and/or the compactor 14.

In one example, the paving machine 12 may embody an asphalt paver. The paving machine 12 includes a tractor 16, The tractor 16 includes a power source (not shown) to propel the paving machine 12 on the worksite 10. The power source is mounted within an enclosure 18. The power source may include an engine. The tractor 16 also includes an operator station 20 and one or more traction devices 22. Although the traction devices 22 shown in the accompanied figures are wheels, the traction devices 22 could alternatively be tracks or any other type of traction device known in the art. In one example, the traction devices 22 could also be combinations of different types of traction devices. For example, the paving machine 12 could include both tracks and wheels.

The paving machine 12 also includes a screed 24. The screed 24 may be coupled to a rear end of the tractor 16. The screed 24 may be towed behind the tractor 16 to spread and compact paving material on a surface of the worksite 10. The screed 24 may include one or more augers (not shown) for spreading the paving material. A person of ordinary skill in the art will appreciate that the screed 24 described herein is merely on an exemplary basis. The screed 24 may vary based on the type of application. The paving material may include asphalt, soil, gravel, concrete, and the like.

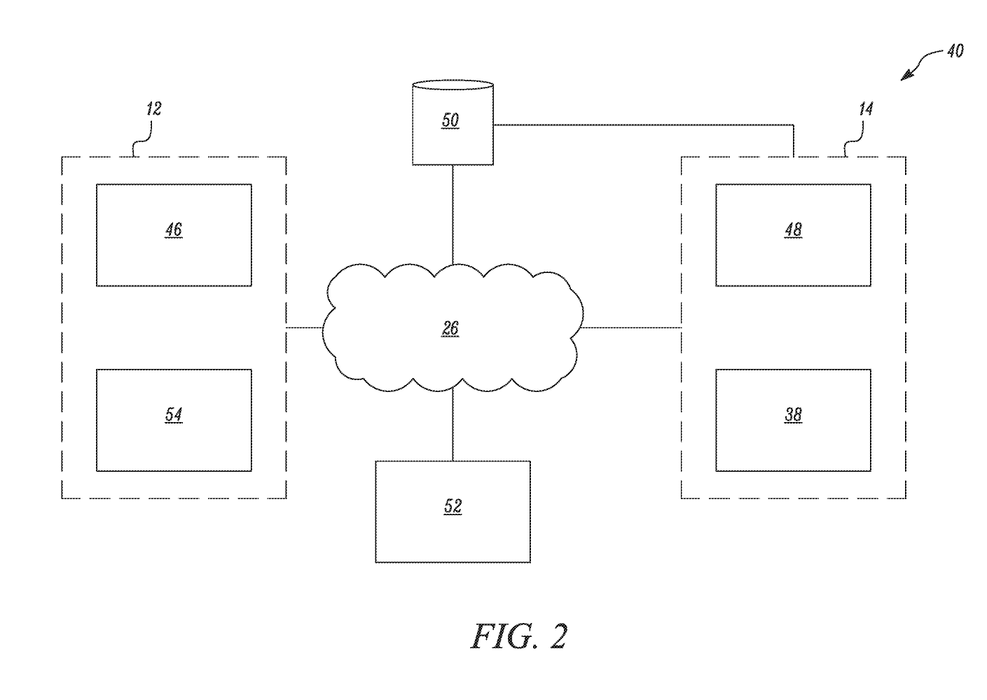

The paving machine 12 includes a first position detection module 46. The first position detection module 46 generates a signal indicative of a current position of the paving machine 12. For example, the first position detection module 46 may embody a Global Positioning System (GPS) of the paving machine 12 that determines the current position of the paving machine 12 at the worksite 10. in some examples, the first position detection module 46 may embody a GPS (not shown) of the worksite 10 that determines the current position of the paving machine 12 at the worksite 10. The paving machine 12 also includes a first speed detection module 47. The first speed detection module 47 generates a signal indicative of a speed of the paving machine 12. For example, the first speed detection module 47 may include a speed sensor that detects the speed at which the paving machine 12 is moving. The paving machine 12 is communicably coupled to the compactor 14 via a communication network 26 (FIG. 2). During a paving operation, the compactor 14 approaches the rear end of the paving machine 12. The compactor 14 includes a frame 28. Further, the compactor 14 includes an operator station 30 mounted on top of the frame 28 from which an operator may control and direct operation of the compactor 14. To propel the compactor 14 over the surface of the worksite 10, a power source (not shown) may be mounted within an enclosure 32. The power source may include an engine.

To enable movement of the compactor 14 on the worksite 10, the compactor 14 includes a first roller drum 34 and a second roller drum 36. The first and second roller drums 34, 36 are in rolling contact with the surface of the worksite 10. The first and second roller drums 34, 36 are also used to compact or compress the paving materials to a densified and more rigid mass or surface. In addition to utilizing a weight of the roller drums 34, 36 to provide the compressive forces that compact the paving material, some compactors may also induce a vibratory force to the surface of the worksite 10. As can be appreciated, the vibratory forces assist in working or compacting the loose materials into a dense, uniformly rigid mass. Further, the compactor 14 includes a braking system 38 (see FIG. 2) for stopping the movement of the compactor 14. In one example, the braking system 38 may embody a hydrostatic braking system. Further, a predefined weight of the compactor 14 may be stored on the compactor 14. In one example, the predefined weight may be stored in a database 50 associated with the compactor 14.

The compactor 14 includes a second position detection module 48. The second position detection module 48 generates a signal indicative of a current position of the compactor 14. For example, the second position detection module 48 may embody a GPS of the compactor 14 that determines the current position of the compactor 14 at the worksite 10. In some examples, the second position detection module 48 may embody the GPS of the worksite 10 that determines the current position of the compactor 14 at the worksite 10. The compactor 14 also includes a second speed detection module 49. The second speed detection module 49 generates a signal indicative of a speed of the compactor 14. For example, the second speed detection module 49 may include a speed sensor that detects the speed at which the compactor 14 is moving.

The present disclosure is directed towards a paving system 40. The paving system 40 stops the compactor 14 based on the compactor 14 entering into a predetermined boundary 42. The term “predetermined boundary” referred to herein is a tolerance zone defined around the paving machine 12, in order to avoid contact of the compactor 14 with one or more components of the paving machine 12.

Referring to FIG. 2, a block diagram of the paving system 40 is illustrated. The paving system 40 includes a controller 52. The controller 52 is communicably coupled to the paving machine 12 and the compactor 14, via the communication network 26. More particularly, the controller 52 is communicably coupled to the first position detection module 46, the first speed detection module 47, the second positon detection module 48, the second speed detection module 49, and the braking system 38 of the compactor 14, via the communication network 26. Further, the controller 52 may also be coupled to the GPS of the worksite 10 via the communication network 26. In one example, the controller 52 may be present onboard the compactor 14 or at the remote location, without limiting the scope of the present disclosure.

The controller 52 receives signals pertaining to the current position of the paving machine 12 and the compactor 14 from the first and second position detection modules 46, 48 respectively. Based on the received signals, the controller 52 calculates a first distance “D1”. The term “first distance D1” referred to herein is defined as a distance between the paving machine 12 and the compactor 14. In one example, the first distance “D1” may be defined between a center of the paving machine 12 and a center of the compactor 14, without any limitations.

The controller 52 also receives the signals pertaining to the speed of each of the paving machine 12 and the compactor 14 from the first and second speed detection modules 47, 49. Further, the controller 52 receives the predefined weight of the compactor 14 from the database 50. Based on the weight and the current speed of the compactor 14, the controller 52 calculates a momentum of the compactor 14.

The controller 52 also determines the predetermined boundary 42 (see FIG. 1) surrounding the paving machine 12. The predetermined boundary 42 is determined based on each of the predefined weight, the speed, the current position, and a hydrostatic braking capability of the compactor 14. It should be noted that the predetermined boundary 42 may change dynamically based on each of the predefined weight, the speed, the current position, and the hydrostatic braking capability of the compactor 14 and also based on the speed and the current position of the paving machine 12. Based on the first distance “D1” and the predetermined boundary 42, the controller 52 calculates a second distance “D2”. The term “second distance D2” referred to herein is a distance between the compactor 14 and the predetermined boundary 42. In one example, the second distance “D2” may be defined between an outer surface of the first roller 34 of the compactor 14 and predetermined boundary 42.

Further, the controller 52 controls the compactor 14 such that the compactor 14 stops based on the entering of the compactor in the predetermined boundary 42. The controller 52 stops the compactor 14 based on the entering of the compactor in the predetermined boundary 42. More particularly, based on the momentum of the compactor 14 and the hydrostatic braking capability of the compactor 14 at the current speed, the controller 52 determines a stopping distance of the compactor 14. The term “stopping distance” referred to herein is defined as a distance that the compactor 14 may travel before completely stopping, when the braking system 38 of the compactor 14 is activated.

The hydrostatic braking capability of the compactor 14 may be stored in the database 50 associated with the compactor 14 and can be retrieved by the controller 52 therefrom. The hydrostatic braking capability of the compactor 14 is different at different speeds of the compactor 14. Further, in some examples, the stopping distance of the compactor 14 for various speed ranges may already be stored in the database 50 of the compactor 14. Thus, based on the current speed of the compactor 14, the controller 52 may retrieve the stopping distance from the database 50.

Based on the stopping distance, the controller 52 controls the compactor 14 such that the compactor 14 stops based on the entering of the compactor in the predetermined boundary 42. More particularly, the controller 52 activates the braking system 38 of the compactor 14 to stop the compactor 14. The controller 52 may activate the braking system 38 at a third distance “D3” from a current position of the compactor 14, such that the compactor 14 stops on entering the predetermined boundary 42. In such examples, the speed of the compactor 14 gradually reduces, and the compactor 14 stops completely on entering the predetermined boundary 42. The term “third distance D3” referred to herein is a difference between the second distance “D2” and the stopping distance. In some examples, where the braking system 38 is not capable of gradually reducing the speed of the compactor 14, the controller 52 may activate emergency brakes of the compactor 14 to stop the compactor 14.

In other examples, the controller 52 may calculate a relative speed between the paving machine 12 and the compactor 14 to determine time to an imminent contact between the paving machine 12 and the compactor 14. Based on the determination, the controller 52 may activate the braking system 38 of the compactor 14 at a time instance such that the compactor 14 does not contact the paving machine 12.

The communication network 26 may embody a network that is capable of receiving and transmitting information from the paving machine 12, the compactor 14, and the controller 52, without limiting the scope of the present disclosure. The communication network 26 may include, but is not limited to, a wide area network (WAN), a local area network (LAN), a Bluetooth, an Ethernet, an internet, an intranet, a cellular network, a satellite network, or any other network for transmitting data. In various examples, the communication network 26 may include a combination of two or more of the aforementioned networks and/or other types of networks known in the art. The network may be implemented as a wired network, a wireless network, or a combination thereof Further, the data may be transmitted over the communication network 26 through a network protocol, for example, in an encrypted format, or any other secure format known in the art.

Further, the controller 52 may embody a single microprocessor or multiple microprocessors. Numerous commercially available microprocessors can be configured to perform the functions of the controller 52. The controller 52 may include all the components required to run an application such as, for example, a memory, a secondary storage device, and a processor, such as a central processing unit or any other means known in the art. Various other known circuits may be associated with the controller 52, including power supply circuitiy, signal-conditioning circuitry, communication circuitry, and other appropriate circuitry.

### INDUSTRIAL APPLICABILITY

The present disclosure relates to the paving system 40. The paving system 40 eliminates collision between the compactor 14 and the paving machine 12 by stopping the compactor 14 based on the entering of the compactor 14 into the predetermined boundary 42 surrounding the paving machine 12. As the paving system 40 avoids collision between the compactor 14 and the paving machine 12, downtime and maintenance cost associated with the compactor 14 and the paving machine 12 is reduced.

The paving system 40 provides a real time and low cost system for collision avoidance as the paving system 40 utilizes information that is readily available without using costly sensors. The paving system 40 provides a reliable and accurate system for collision avoidance. Further, based on the capabilities of the braking system 38 of the compactor 14, the controller 52 of the paving system 40 is programmed to either activate the braking system 38 to gradually reduce the compactor speed gradually or activate the emergency brakes for stopping of the compactor 14. Thus, the paving system 40 prevents collision between the compactor 14 and the paving machine 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A paving system comprising:
a paving machine having a screed, the paving machine including:
a first position detection module configured to generate a signal indicative of a current position of the paving machine; and
a first speed detection module configured to generate a signal indicative of a speed of the paving machine;
a compactor having a predefined weight stored thereon, the compactor including:
a second position detection module configured to generate a signal indicative of a current position of the compactor; and
a second speed detection module configured to generate a signal indicative of a speed of the compactor; and
a controller in communication with the paving machine and the compactor, the controller configured to:
receive the signals indicative of the current position of each of the paving machine and the compactor respectively;
receive the signals indicative of the speed of each of the paving machine and the compactor respectively, and the predefined weight of the compactor;
determine a predetermined boundary surrounding the paving machine based on the predefined weight, the speed, and the current position of the compactor; and
stop the compactor based on entering into the predetermined boundary, wherein the stopping is based on hydrostatic braking capability of the compactor.
